(19) United States
(12) Patent Application Publication
(10) Pub. No.: US 2015/0269779 A1
(43) Pub. Date: Sep. 24, 2015

(54) Head-Mounted Augumented Reality Display System

(71) Applicant: Syndiant Inc., Dallas, TX (US)

(72) Inventors: Chun Chiu Daniel Wong, Dallas, TX (US); Po Wing Cheng, Dallas, TX (US)

(21) Appl. No.: 14/659,884

(22) Filed: Mar. 17, 2015

(30) Foreign Application Priority Data
Mar. 20, 2014 (TW) 103110547

(51) Int. Cl. G06T 19/00; G02B 27/01; H04N 5/374

(52) U.S. Cl. CPC G06T 19/006; H04N 5/374; G02B 27/0172; G02B 27/0176; G06T 2215/16; G02B 2027/0178

(57) ABSTRACT

A head-mounted augmented reality display system, comprise: an immersive or see-through type near-to-eye viewing optics; a CMOS image sensor; a sound receiver; an earphone; a driver system board; and a frame. The image sensor and the sound receiver capture the image and record the sound from the outside world to the driver system. By the image and audio processing of the driver system, the generated image outputs to the immersive or see-through type near-to-eye viewing optics, and the generated audio outputs to the ear phone.

This application claims priority to Taiwan Patent Application No. 103110547 filed on Mar. 20, 2014.

### CROSS-REFERENCES TO RELATED APPLICATIONS

Not applicable.

### BACKGROUND OF THE INVENTION

1. Field of the Invention

The present invention relates to a head-mounted augmented reality display system, particularly comprising a complementary metal-oxide-semiconductor (CMOS) image sensor and a sound receiver.

2. Descriptions of the Related Art

With the development of technology, the mobility and interactivity of a display system improves significantly. Products integrating display systems and other devices (e.g. glasses) come up in the market and thus, consumers can use such products to view graphs or images anywhere and anytime.

One prior art is a wearable device with input and output structures (United States Patent Publication No. 2013/0044042) as shown in FIG. 1. The wearable device can process images shot by a camera on one side of a glasses frame and display onto one side of lens (monitor). However, such device has following drawbacks. The first problem comes from a single camera, which only takes narrow view and is unable to present stereoscopic images. The second problem is that such device cannot augment reality “acoustically” due to lack of a microphone, an earphone or an audio jack. The third problem is that such device utilizes LCD (Liquid Crystal Display), CRT (Cathode Ray Tube) or OLED (Organic Light-Emitting Diode) as display system, wherein the resolution and saturation images of the first two types of display system is poor despite its low costs, and the OLED (Organic Light-Emitting Diode) display system has the problem for the short lifecycle and high costs, as well as complicated manufacture process and difficulties of mass production.

### SUMMARY OF THE INVENTION

To overcome these problems, the present invention provides a head-mounted augmented reality display system, having a direct view type (such as LCD, LED or OLED) or a projecting type (such as Liquid Crystal on Silicon (LCOS)) near-to-eye viewing optics. The LCOS display system of the present invention has the advantages of smaller size, higher resolution, higher contrast, shorter response time, lower costs and easier to manufacture over the prior arts. The present invention can present stereo augmented reality effects with high definition (HD) video and audio from the externally captured images and sounds by immersive or see-through type near-to-eye viewing optics.

To achieve the above objectives, the present invention provides a head-mounted augmented reality display system, comprising a driver system board for generating and processing images and sounds; a CMOS image sensor for capturing external real images to the driver system board; an immersive or see-through type near-to-eye viewing optics (hereinafter referred to as “optics”) for casting images from the driver system board on user's vision; an earphone; a sound receiver for recording external sound to the driver system board before transmitting to the earphone; and a frame configured to be mountable on the head of a user for carrying the near-to-eye viewing optics, the CMOS image sensor, the earphone and the sound receiver.

To enhance the quality of stereo augmented reality, this invention provides another embodiment of head-mounted augmented reality display system, comprising a driver system board for generating and processing images and sounds; two CMOS image sensors for capturing external images to the driver system board; two immersive or see-through type near-to-eye viewing optics for casting images from the driver system board on user's vision; two earphones; two sound receivers for recording external sounds to the driver system board before transmitting to the earphones; and a frame configured to be mountable on the head of a user for carrying the near-to-eye viewing optics, the CMOS image sensors, the earphones and the sound receivers.

The detailed technology and preferred embodiments implemented for the subject invention are described in the following paragraphs accompanying the appended drawings for people skilled in this field to well appreciate the features of the claimed invention.

The above summary and following detailed descriptions are exemplary and illustrative for further explaining the claims of the subject invention. Other objectives and advantages will be further illustrated in the following descriptions and graphs.

### BRIEF DESCRIPTION OF THE DRAWINGS

FIG. 1 is a diagram of a head-mounted augmented reality display system of the prior art;

FIG. 2 is a diagram of a head-mounted augmented reality display system in accordance with the first embodiment of the subject invention;

FIG. 3 is the structure diagram of the color-filter type near-to-eye viewing optics of the subject invention;

FIG. 4 is the structure diagram of the color sequential type near-to-eye viewing optics of the subject invention;

FIG. 5 is the diagram of a head-mounted augmented reality display system in accordance with the second embodiment of the subject invention;

FIG. 6A is the front view of a head-mounted augmented reality display system in accordance with the third embodiment of the subject invention;

FIG. 6B is the back view of a head-mounted augmented reality display system in accordance with the third embodiment of the subject invention;

FIG. 6C is a front view of a head-mounted augmented reality display system in use in accordance with the third embodiment of the subject invention; and

FIG. 6D is a back view of a head-mounted augmented reality display system in use in accordance with the third embodiment of the subject invention.

### DESCRIPTION OF THE PREFERRED EMBODIMENT

The contents of the subject invention will be explained through the following embodiments. However, the embodiments of the subject invention are illustrative and shall not be used as limitation to practice the subject invention. Furthermore, some elements that are relative to contents of the subject invention that persons skilled in this field can understand have been omitted and no illustrated. Persons skilled in the art can realize that the head-mounted augmented reality display system disclosed in the subject invention can be utilized in various different occasions.

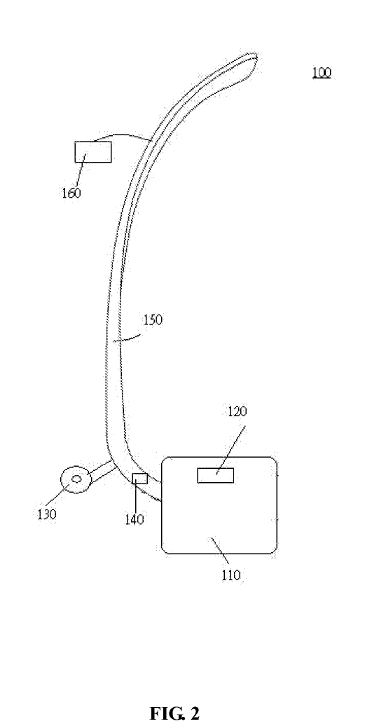

FIG. 2 illustrates the front appearance view of a head-mounted augmented reality display system 100. FIG. 2 shows the first embodiment, which comprises a driver system board 160 for generating an image and a sound; a near-to-eye viewing optics 110 for casting images with 720p, 1080i, 1080p and other high definition from the driver system board 160 on user's vision. Users can either view projected HD images on the glasses with projecting type near-to-eye viewing optics 110, or view image directly from the naked eyes with direct view type near-to-eye viewing optics 110. Immersive type near-to-eye viewing optics 110 can present images completely “covering” the sight of users and thus, provide better perceptual visual quality but less safety and convenience for users wore such device outdoors, in dangerous environment or in moving condition. Therefore, this invention provides a see-through type near-to-eye viewing optics 110 without backlight and thus has the advantages of smaller volume and thinner. Although such optics 110 cannot present images completely “covering” the sight of users, the users can perceive the environment behind the optics 110 and thus such optics is more suitable to be used outdoor, in dangerous environment or in moving condition.

In addition, in the first embodiment of subject invention comprises a CMOS image sensor 120 for capturing external real images to the driver system board 160 which outputs single image to near-to-eye viewing optics 110, including internal images which are stored or downloaded by the driver system board 160, integrated images, which are integrated with external images and internal images, or multiple images, such as Picture by Picture (PBP), Picture in Picture (PIP), Picture out Picture (POP). For example, users can see how the weather is (sunny or cloudy) through or on the near-to-eye viewing optics 110. The driver system board 160 will indicate weather condition by showing current temperature, humidity, probability of precipitation or even 7-days forecast on the near-to-eye viewing optics 110 in single or multiple graphs. Other applications such as users can simultaneously watch several TV channels, surveillance monitors or combination of different images. Stereoscopic vision will be created by parallax with the multi-angle images captured from different positions by the CMOS image sensor 120, processed by the driver system board 160 and displayed by near-to-eye viewing optics 110. In other words, the driver system board 160 can convert original images or graphs into stereoscopic ones, and additional functions such as multimedia player or connect to Wi-Fi can be incorporated.

Furthermore, in the first embodiment of the subject invention comprises an earphone 130 and a sound receiver 140 for recording external sound to the driver system board 160 before transmitting sound to the earphone 130. The earphone 130 can play external sounds or internal sounds (multimedia information stored or downloaded by the driver system board 160) separately or in mixture. The potential drawback is that users may not perceive the change of the external environment when they view the images on the near-to-eye viewing optics 110 and listen to the sound from the earphone 130 at the same time. Users may miss the bus stop or offensively ignore friends if they immersed themselves in the joy from this invention. Therefore, in a preferred embodiment of the first embodiment, a high-sensitivity sound receiver is used as sound receiver 140 so as to automatically switch sound outputting to the earphone 130 in accordance with the volume, direction or the frequency of the external sound received by the sound receiver 140. For example, when the earphone 130 only outputs internal sound, the driver system board 160 will automatically switch the mode of output in accordance default setting in the factory or user adjustment when detecting a specific frequency external sound, such as human sound, animal sound, or firecracker sound or footstep sound, or detecting a certain volume of external sound. The above automatic switch can be from only outputting internal sound to only outputting external sound, or both outputting internal sound and external sound together with the adjustment of the volume of these two type of sounds Accordingly, the automatic switch of sounds can improve the above drawback.

Furthermore, in the first embodiment of the subject invention comprises a frame 150 mountable on the head of a user for carrying the near-to-eye viewing optics 110, the CMOS image sensor 120, the earphone 130 and the sound receiver 140. As shown in FIG. 2, the driver system board 160 can be set up either outside the frame transmitting wireless or wired signals or inside the frame (not shown in FIG. 2).

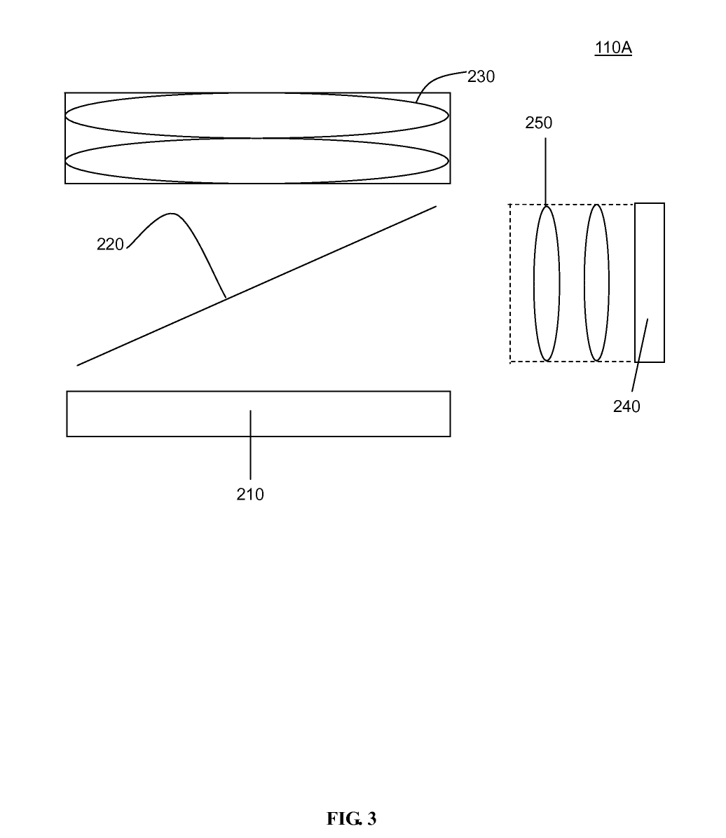

FIG. 3 illustrates the color-filter type near-to-eye viewing optics 110A, comprising a LCOS panel 210 with color filter (not shown), Polarization Beam Splitter (PBS) 220, optical eyepiece 230, white Light-Emitting Diode (LED) illumination system 240 and concentrator 250. The white LED illumination system 240 outputs light to the concentrator 250 which will concentrate light on the PBS 220 before the PBS 220 reflects light to the color filter on the panel 210 splitting white light into red, green and blue. Afterward, the panel reflects red, green and blue light to the optical eyepiece 230 and then casting images on user's vision. However, the drawback of the near-to-eye viewing optics 110A is that color saturation and luminous efficiency decreases due to light absorption in the color filter.

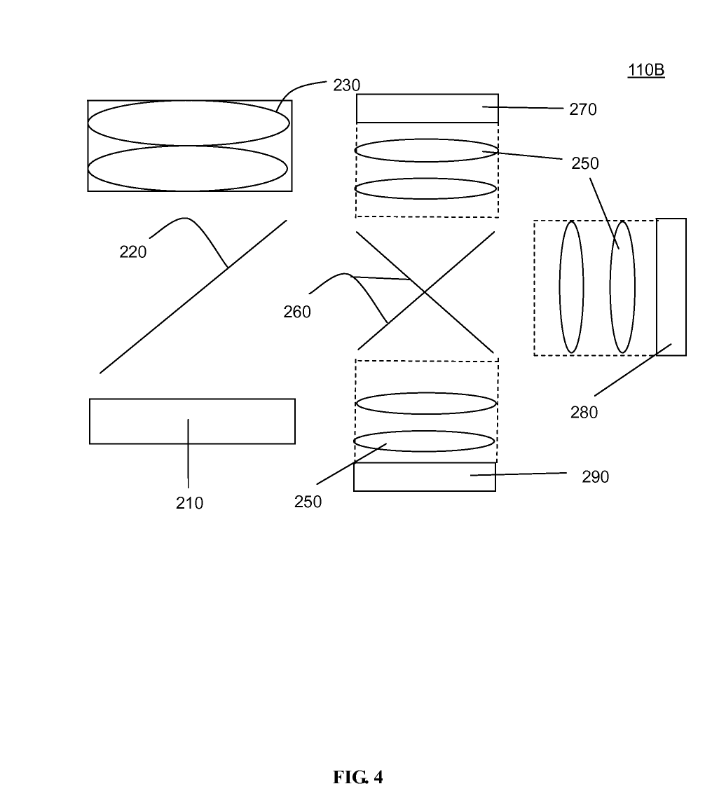

To overcome the weakness of the color-filter type near-to-eye viewing optics 110A, this invention provides color sequential type near-to-eye viewing optics 110B as shown in FIG. 4, comprising a LCOS panel 210, Polarization Beam Splitter (PBS) 220, Dichroic Mirror 260, optical eyepiece 230, concentrator 250, blue LED illumination system 270, green LED illumination system 280, and red LED illumination system 290. The blue, green and red LED illumination systems 270, 280, 290 respectively output light to the concentrator 250 which concentrates light on the Dichroic Mirror 260 before the Dichroic Mirror 260 reflects light on the PBS 220 which reflects light to the panel 210. Lastly the panel 210 reflects light to the eyepiece 230 and casts images on user's vision. Blue, green and red LED illumination systems 270, 280, 290 on the near-to-eye viewing optics 110B overcome the drawback of decreased luminous efficiency by representing color with high saturation without a color filter.

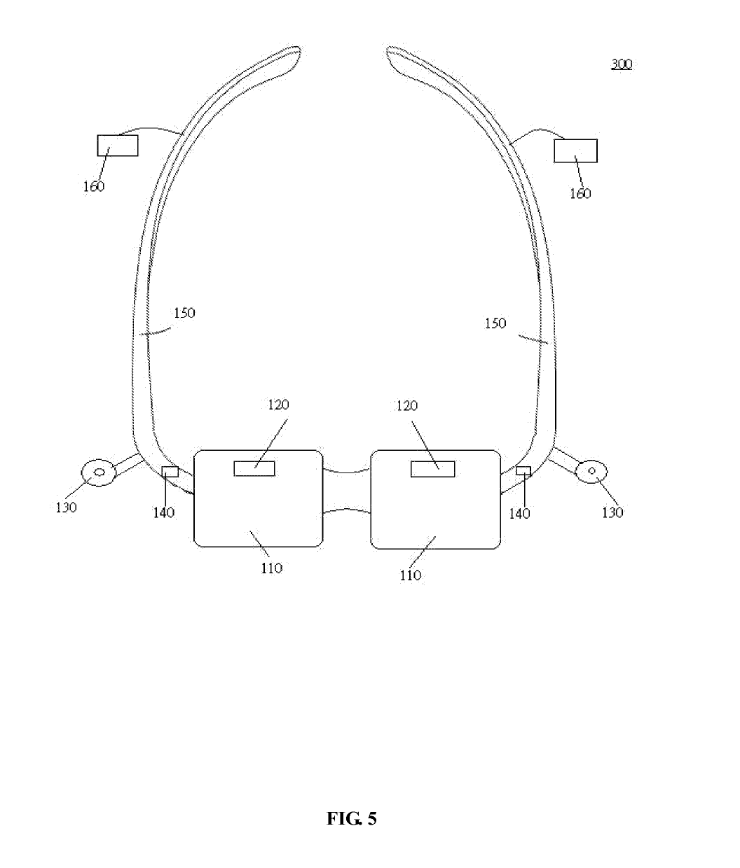

FIG. 5 illustrates the second embodiment as a further application of the first embodiment about this invention, which is a binocular head-mounted augmented reality display system 300 integrating two sets of the first embodiment 100 with necessary adjustment, comprising a driver system board 160 for generating an image and a sound, two CMOS image sensors 120 for capturing external real images to the driver system board 160, two near-to-eye viewing optics 110 for casting an image from the driver system board on the user's vision, two earphones 130, two sound receivers 140 for recording external sounds on the driver system board 160 before transmitting sounds to the earphones 130; and a frame 150 mountable on the head of a user for carrying the near-to-eye viewing optics 110, the CMOS image sensors 120, the earphones 130 and the sound receivers 140. The driver system board 160 can be set up either outside the frame 150 through wire or wirelessly for signal transmission or inside the frame 150 (not shown). In a preferred second embodiment, a plurality of driver system boards 160 can be integrated into a single driver system board 160 (not shown)

In addition to all function of the first embodiment, the second embodiment further comprise a stereo video and audio function by using two near-to-eye viewing optics 110, two CMOS image sensors 120, two sound receivers 140 and two earphones 130. Stereoscopic vision will be created by parallax with the multi-angle images captured from different positions by the CMOS image sensors 120, processed by the driver system board 160 and displayed on near-to-eye viewing optics 110. In other words, the driver system board 160 can convert original images or graphs into stereoscopic displays, and additional functions such as multimedia player or connect to Wi-Fi can be incorporated. Likewise, multichannel stereo audio will be outputted with multi-angle sound captured from different positions by the sound receivers 140, processed by the driver system board 160 and played by the earphones 130. The second embodiment can overcome the drawback in the prior art that change of outside environment cannot be easily perceived by using the above mentioned automatic switch sound sources mechanism.

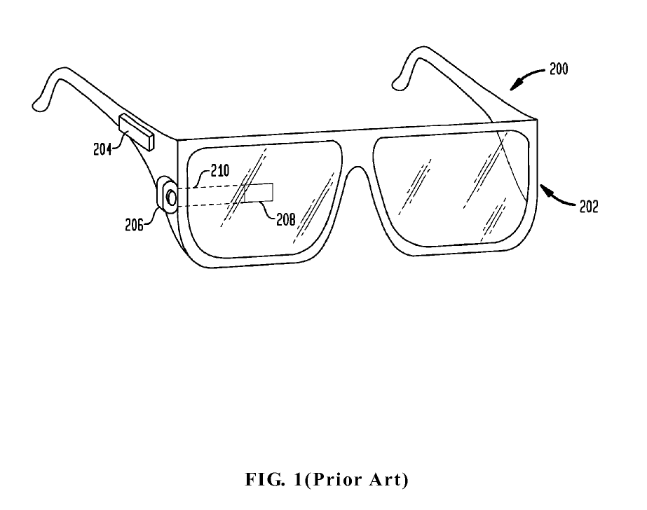

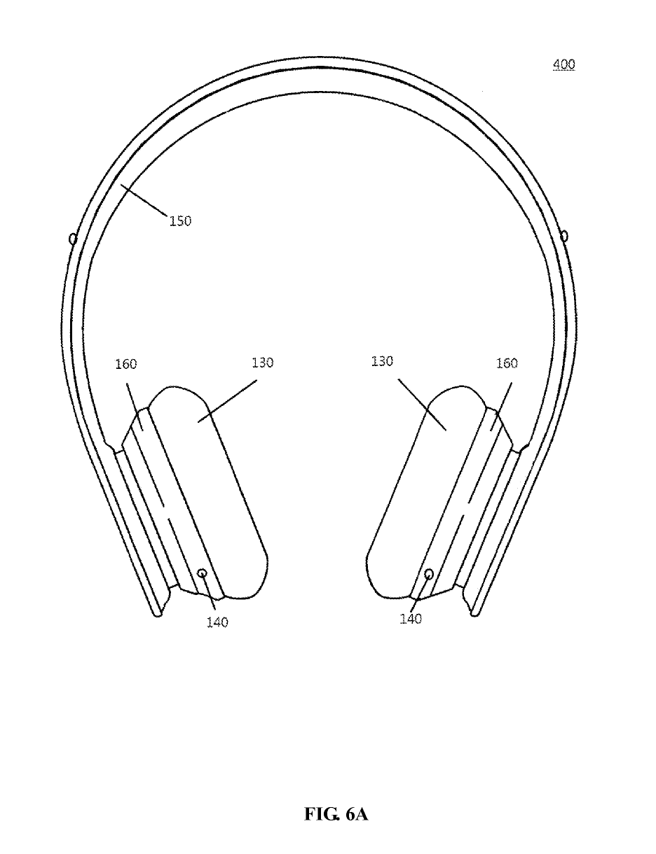

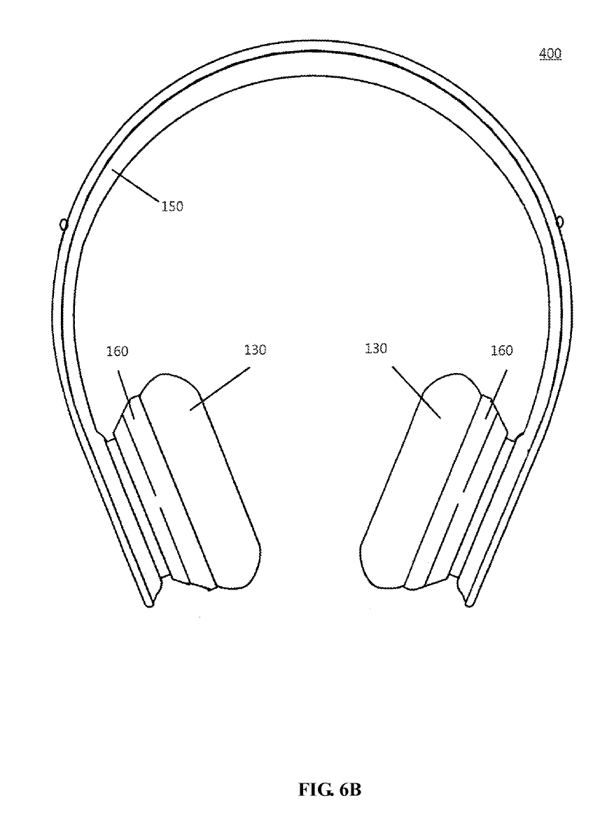

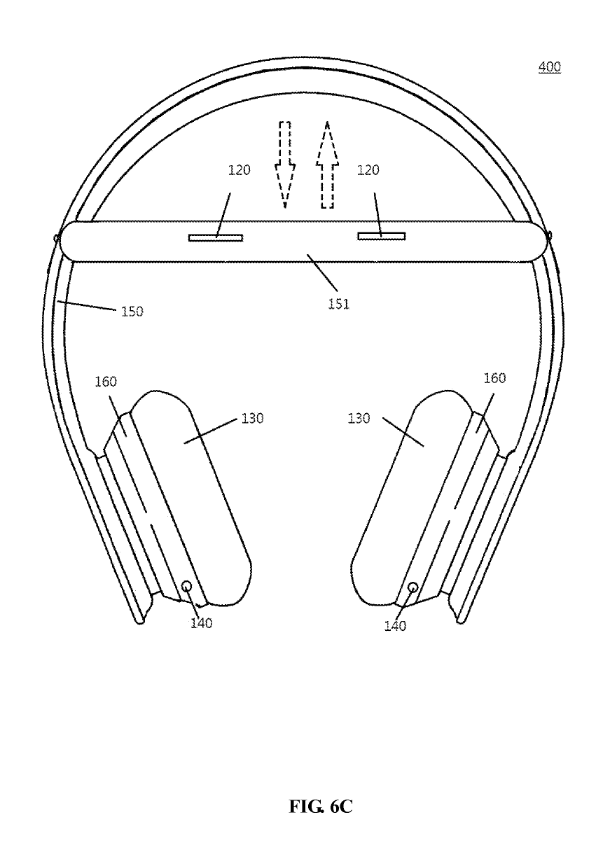

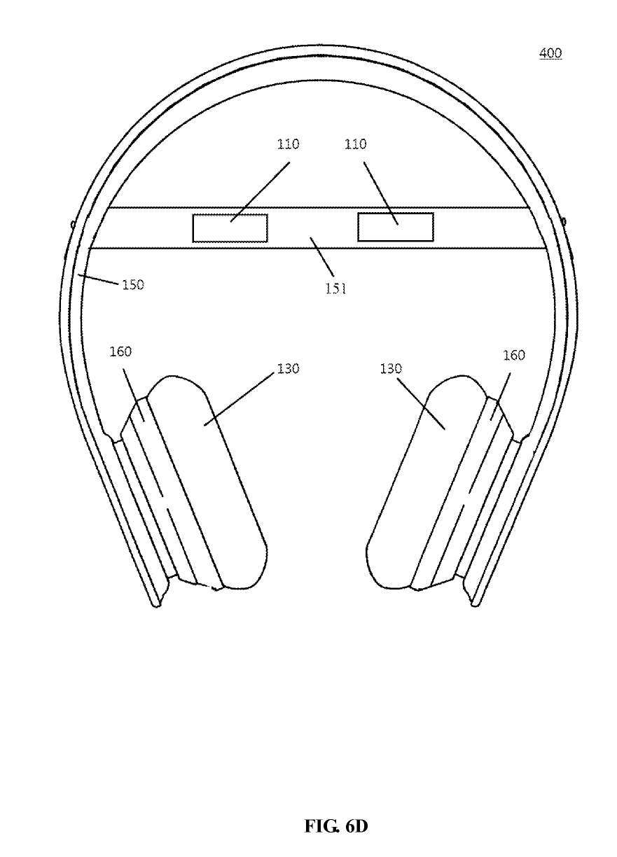

FIGS. 6A-D illustrate the third embodiment as a further application of the second embodiment about this invention, which is a foldable binocular head-mounted augmented reality display system 400. The third embodiment shares the same hardware structure of the second embodiment with a major difference by installing near-to-eye viewing optics 110 and CMOS image sensor 120 on the a foldable frame 151, not on the frame 150. The foldable frame 151 is movable in the vertical direction relative to the user's eyes. This design can relieve eye strain or other discomforts for some user using the head-mounted augmented reality display system. In addition, such design makes easy storage of this device after use. Please refer to FIG. 1, prior art (e.g. United States Patent Application 20130044042) failed to disclose foldable frame 151 design and thus, users need to take off the glasses to relieve eye strain or get a full view behind the glasses. In addition, prior art failed to resolve the problem of glasses storage, losing or damage. The foldable frame 151 in this invention can improve the above problem and have users relieve eye strain, get a full view behind the glasses and store this device easily. Furthermore, this design can save battery power. Please refer to FIG. 6C, users can pull up the foldable frame 151 along the dashed arrow when they want to get a full view behind the glasses or relieve eye strain. The screen of the near-to-eye viewing optics 110 will automatically turn off or the system 400 will enter a sleep state according to default setting in the factory or users adjustment so as to save power. Users can pull down the foldable frame 151 along the dashed arrow to turn on the screen or waken the system 400 from a sleeping mode.

The above disclosures are related to the detailed technical contents and inventive features thereof. Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A head-mounted augmented reality display system, comprising:
a driver system board for generating an image and a sound;
a near-to-eye viewing optics including a LCOS panel and a LED illumination system, wherein the LCOS panel is color sequential LCOS or color filter LCOS, wherein the near-to-eye viewing optics capture the image from the driver system board so as to provide a viewing field of an user in the front of his eyes;
a CMOS image sensor for capturing an external real image to the driver system board;
a sound receiver and an earphone, wherein the sound receiver records an external sound to the driver system board and outputs the sound to the earphone, and the driver system board can store or download multimedia information as an internal sound, wherein the sound outputs to earphone is the external sound received by the sound receiver, internal sound of the driver system board, or the combination of the external sound and the internal sound; and
a frame mountable on the head of the user for carrying the near-to-eye viewing optics, the CMOS image sensor, the earphone and the sound receiver.

2. The head-mounted augmented reality display system of claim 1, wherein the LED illumination system of the near-to-eye viewing optics can be a plurality of red, green and blue LEDs, or white light LEDs.

3. The head-mounted augmented reality display system of claim 1, wherein the driver system board further includes a function of multimedia player, Wi-Fi or converting original images or graphs into stereoscopic displays.

4. The head-mounted augmented reality display system of claim 1, wherein the sound outputting to the earphone can be manually switched by the user from the external sound received by the sound receiver, internal sound of the driver system board, or the combination of the external sound and the internal sound.

5. The head-mounted augmented reality display system of claim 1, wherein the sound outputting to the earphone can be automatically switched from the external sound received by the sound receiver, internal sound of the driver system board, or the combination of the external sound and the internal sound by the driver system board based on the volume, direction or the frequency of the external sound received by the sound receiver.

6. The head-mounted augmented reality display system of claim 1, wherein the driver system board can output single or multiple images to the near-to-eye viewing optics.

7. The head-mounted augmented reality display system of claim 1, wherein the near-to-eye viewing optics can be immersive or see-through type.

8. The head-mounted augmented reality display system of claim 1, wherein the near-to-eye viewing optics can be display system selected from LCOS, liquid crystal display, LED or OLED.

9. A head-mounted augmented reality display system, comprising:
a driver system board for generating an image and a sound;
two near-to-eye viewing optics, wherein the near-to-eye viewing optics includes a LCOS panel and a LED illumination system, wherein the LCOS panel is color sequential LCOS or color filter LCOS, wherein the near-to-eye viewing optics capture the image from the driver system board so as to provide
a viewing field of an user in the front of his eyes;
two CMOS image sensors for capturing external real images to the driver system board;
two sound receivers and two earphones, wherein the sound receiver records an external sound to the driver system board and outputs the sound to the earphone, and the driver system board can store or download multimedia information as an internal sound, wherein the sound outputs to earphone is the external sound received by the sound receiver, internal sound of the driver system board, or the combination of the external sound and the internal sound; and
a frame mountable on the head of the user for carrying the near-to-eye viewing optics, the CMOS image sensor, the earphone and the sound receiver.

10. The head-mounted augmented reality display system of claim 9, wherein the LED illumination systems of the near-to-eye viewing optics can be a plurality red, green and blue LEDs, or white light LEDs.

11. The head-mounted augmented reality display system of claim 9, wherein the driver system board further includes a function of multimedia player, Wi-Fi or converting original images or graphs into stereoscopic ones.

12. The head-mounted augmented reality display system of claim 9, wherein the sound outputting to the earphone can be manually switched by the user from the external sound received by the sound receiver, internal sound of the driver system board, or the combination of external sound and internal sound.

13. The head-mounted augmented reality display system of claim 9, wherein the sound outputting to the earphone can be automatically switched from the external sound received by the sound receiver, internal sound of the driver system board, or the combination of external sound and internal sound by the driver system board based on the volume, direction or the frequency of the external sound received by the sound receiver.

14. The head-mounted augmented reality display system of claim 9, wherein the CMOS image sensors can capture multi-angle images and transmit to the driver system board to generate stereoscopic images or graphs.

15. The head-mounted augmented reality display system of claim 9, wherein the driver system board can output single or multiple images to the near-to-eye viewing optics.

16. The head-mounted augmented reality display system of claim 9, wherein the near-to-eye viewing optics can be immersive or see-through type.

17. The head-mounted augmented reality display system of claim 9, wherein the near-to-eye viewing optics can be display system selected from LCOS, liquid crystal display, LED or OLED.

18. The head-mounted augmented reality display system of claim 9, wherein the frame further comprises a foldable frame so as to be movable in the vertical direction relative to the user's eyes.

19. The head-mounted augmented reality display system of claim 18, wherein the near-to-eye viewing optics and the CMOS image sensors are embedded in the foldable frame.

20. The head-mounted augmented reality display system of claim 18, wherein the foldable frame is pulled up to turn off the near-to-eye viewing optics or to have the head-mounted augmented reality display system enter into a sleep mode; wherein the foldable frame is pulled down to turn on the near-to-eye viewing optics or to have the head-mounted augmented reality display system waken from the sleeping mode.
